(19) United States
(12) Patent Application Publication
(10) Pub. No.: US 2012/0266987 A1
(43) Pub. Date: Oct. 25, 2012

(54) Coupling Body for Use in a Fuel Supply System, Coupling Housing, Coupling Member, Fuel Supply System Provided with Such a Coupling Body and Vehicle Provided with Such a Fuel Supply System

(76) Inventors: Servatius Alfons Maria Jaasma, Eindhoven (NL); Bob Alexander Beem, Helmond (NL)

(21) Appl. No.: 13/502,990

(22) PCT Filed: Nov. 4, 2010
(86) PCT No.: PCT/NL2010/050735

§ 371 Date: Jul. 2, 2012

(30) Foreign Application Priority Data
Nov. 4, 2009 (NL) 2003753

(51) Int. Cl. A23G 9/28

(52) U.S. Cl. 137/602

(57) ABSTRACT

The invention relates to a coupling body (10) provided with a first supply conduit (100) for receiving a first fuel fluid and a first discharge conduit for discharging the first fuel fluid. The first supply conduit (100) in the coupling body (10) is connected to the first discharge conduit (100) in order to form a first fluid connection for the first fuel fluid from the first supply conduit (100) to the first discharge conduit (100). The coupling body (10) is provided with a receiving chamber (150,51,52). The first supply conduit (100) is connected to the receiving chamber (150,51,52). The first discharge conduit (100) is connected to the receiving chamber (100,51,52). In the receiving chamber (50,51,52), a coupling member (56,57) is arranged, wherein the coupling member (56,57) and the receiving chamber (50,51,52) cooperate in order to form the first fluid connection.

The invention relates to a coupling body for use in a fuel supply system. In addition, the invention relates to components for such a coupling body, and to a fuel supply system comprising such a coupling body and an internal combustion engine comprising such a system. The invention relates in particular to systems in which a liquefied gas fuel is used.

An internal combustion engine is generally known. An internal combustion engine for petrol can also be used for combusting liquefied vapour, such as LPG. In one application, the so-called bi-fuel system, two fuel stores are provided, petrol and LPG, which can be connected to the combustion chamber as desired by the user via a fuel supply system.

Internal combustion engines are supplied by car manufacturers ready made, in particular for passenger cars. It is possible to connect an LPG built-in installation to current internal combustion engines, thus creating a bi-fuel system. In another embodiment, a fuel supply system for liquefied vapour completely replaces the original petrol fuel supply system and a single fuel system is obtained.

DE 10 2005 001210 A1 discloses a dual fuel system which can be operated both on vegetable oil and diesel. To this end, it is known to use a coupling body to which the intakes of both fuel tanks are connected and to bring the shut-off valves for the different fuels to different positions by means of a common control mechanism so that operation with one or the other fuel is possible.

The invention relates in particular to a coupling body for such built-in systems which can be connected to a petrol internal combustion engine and by means of which a single or bi-fuel LPG system can be obtained.

During installation of such built-in systems, the original petrol lines have to be detached, after which the petrol and/or LPG fuel stores have to be reconnected to the internal combustion engine via petrol lines and/or LPG lines, so that the internal combustion engine can be supplied with LPG (in a single fuel system) or the internal combustion engine can be supplied with petrol and/or LPG (in a bi-fuel system), in which case use can be made of various valves for selecting the fuel supply from the petrol or LPG fuel store.

In order to connect the petrol and/or LPG fuel stores (low pressure and high pressure, respectively) to the internal combustion engine, it is known to use a coupling body cast from a light metal to which the respective fuel supply lines for petrol and/or LPG are connected, and from which a discharge line can pass the selected fuel to the combustion chamber of the internal combustion engine. Various functionalities, such as valve functions, may be incorporated in the coupling body. In general, a coupling body which is as compact as possible is used. When a highly pressurized fuel, such as LPG, is used, the coupling body generally has to be a strong body. In addition, due to the positioning of the coupling body and the possible locations of the fuel supply lines and the discharge line, it is often necessary to provide couplings at an angle and/or offset and/or branching into several lines in the coupling body.

A known coupling body is provided with a first supply conduit for receiving a first fuel fluid and a first discharge conduit for discharging the first fuel fluid, which first supply conduit in the coupling body is connected to the first discharge conduit in order to form a first fluid connection for the first fuel fluid from the first supply conduit to the first discharge conduit. In the known coupling body, the supply and discharge conduits are connected to one another. By connecting the first supply conduit to a fuel supply line and the first discharge bore to the discharge line, a fluid connection is thus obtained.

It may be a drawback of such a known coupling body that the production thereof requires a high degree of alignment between the bored supply and discharge conduits. It may be another drawback of such a known coupling body that, when the coupling body comprises several supply conduits and discharge conduits, the coupling body requires a certain minimum dimension in order to be able to compensate for tolerances due to the alignment of the bores.

In addition, problems arise when operating a fuel which is gaseous under atmospheric conditions and a fuel which is liquid under the same conditions, as there may be pressure differences in the supply pressure of the different fuels. Such pressure differences may also occur for many other reasons.

If it is desired to switch from one fuel to the other fuel when there is a pressure difference between the first and second supply conduit, this may lead to complications. These mainly occur if the fuel supplied at a higher pressure has to be switched to a fuel supplied at a lower pressure. It is therefore an object to provide a coupling body which can be produced in a more simple way, in particular when more conduits have to be formed in the coupling body.

According to an aspect of the present invention, this object is achieved by a coupling body having the features of claim 1.

The fluid connection between the first supply conduit and the first discharge conduit is thus not formed by directly connecting or precisely aligning the two bores with each other, but by means of an intermediary space, which may have such a dimension, shape and orientation that it compensates for all these tolerances associated with the production of the two bores. This intermediary space is formed by the cooperation between the receiving chamber and a coupling member which is arranged therein and forms, at least part of, the first fluid connection from the first supply conduit to the first discharge conduit. The coupling member may furthermore be formed such that the coupling member in the receiving chamber defines a spatial area to which the first flow conduit is limited. The volume of the first fluid connection can thus remain limited, even when the receiving chamber has a relatively large volume.

In a preferred embodiment, the first supply conduit and/or the first discharge conduit are formed by a respective bore in the coupling body. The term “bore” is understood to mean a conduit which extends from an outer side of the coupling body to the inner side of the coupling body, in particular to the receiving chamber in the coupling body. The term “bore” can refer to a conduit produced by drilling. The term “bore” may also refer to a conduit which is produced in any other suitable manner, for example by using, during the casting of a cast coupling body, sticks which may optionally be introduced and removed and which extend from the mould into the casting during the casting process and which may be removed therefrom after casting in order to be able to detach the coupling piece from the mould.

In a preferred embodiment, the receiving chamber has a cross section which is at least 3, preferably at least 5, more preferably at least 10, times the smallest diameter of the diameter of the first supply conduit and the diameter of the first discharge conduit. By means of such a relatively large receiving chamber, it is possible to compensate all kinds of tolerances occurring during production in an advantageous manner. Such a relatively large receiving chamber may in this case or in addition be advantageous because it may render producibility of the coupling member easier than for smaller cross sections of the coupling member.

In an embodiment, the receiving chamber comprises a substantially cylindrical bore in the coupling body with an inner wall, and the coupling member comprises a substantially cylindrical element which has a recess on an outer surface thereof for forming the first fluid connection between the inner wall of the substantially cylindrical bore and the recess of the substantially cylindrical element. The first supply conduit thus opens in the space formed by the recess and the first discharge conduit thus extends from the recess, in particular from a different radial position in the recess, and optionally with another orientation and/or, when the recess extends for a certain distance in the length direction of the substantially cylindrical element, at a different longitudinal position in the length direction of the substantially cylindrical element. This makes it possible to form a well-defined fluid flow conduit in the—preferably relatively large—receiving chamber. The cylindrical element may have a bobbinet-like shape. The receiving chamber may, for example, be a bore with a constant, or at least substantially constant, diameter. Alternatively, the receiving chamber may for example be produced in a cast coupling body by means of a, preferably slightly conical and therefore self-releasing, projection in the mould.

In a further embodiment, the coupling member comprises a first shut-off valve for shutting off the first fluid connection between the inner wall of the receiving chamber and the cylindrical coupling member in a longitudinal direction. The shut-off valve may be an O ring. The shut-off valve makes it possible to separate two intermediary spaces from one another. A coupling member may have several shut-off valves in order to separate several chambers from one another.

In a first embodiment, the connection between the supply and discharge conduit comprises a fluid connection which is substantially formed by a first annular flow conduit, which preferably comprises the annular recess on the cylindrical element. The first supply conduit and/or the first discharge conduit open in this flow conduit. The annular flow conduit forms, for example, when both the receiving chamber and the coupling member are substantially cylindrical and concentric, an annular conduit which, at various positions along the periphery and/or along the length direction, is connected to the first supply conduit and the first discharge conduit.

In a second embodiment, the first fluid connection comprises a conduit which is provided inside in the coupling member. The conduit which is provided inside in the coupling member may also be referred to below as an “internal coupling conduit”. For example, the first fluid connection is substantially formed by a first annular flow conduit at a first position in the receiving chamber, with the first supply conduit extending as far as into the first annular flow conduit, by a second annular flow conduit at a second position in the receiving chamber, with the first discharge conduit extending from the second annular flow conduit, and by an internal coupling conduit in the coupling member, which internal coupling conduit connects the first annular flow conduit to the second annular flow conduit. Thus, an offset across larger distances can be achieved between the first supply conduit and the first discharge conduit. In particular, it is possible to hereby obtain a flow conduit when the coupling body has several supply and discharge bores with several annular flow conduits in different positions in a longitudinal direction of the receiving chamber, from the first position to the second position, without there being an exchange with annular flow conduits which are situated between the first position and the second position.

In an embodiment, a non-return valve is incorporated in the fluid connection, in particular in the conduit which is provided inside the coupling member. This prevents a flow in one direction. In particular, the installation of a non-return valve in the internal conduit provides significant spatial advantages. In addition, the valve can readily be replaced by fitting a new coupling member.

In embodiments, the first fluid connection can be fed by a plurality of supply conduits, and/or the first fluid connection can feed a plurality of discharge bores. This is in particular advantageous when fuel liquid has to flow selectively from several supply conduits to a single discharge conduit or when fuel liquid has to flow from a single supply conduit into one selected discharge conduit of a number of discharge conduits. In an embodiment, the coupling body is therefore furthermore provided with a first further discharge conduit for discharging the first fuel fluid, wherein the first further discharge conduit is connected to the receiving chamber, and wherein the first fluid connection also discharges the first fuel fluid to the first further discharge conduit. In an alternative or further embodiment, the coupling body is therefore furthermore provided with a second supply conduit for receiving the first or a second fuel fluid and a second discharge conduit for discharging the first or the second fuel fluid, wherein the second supply conduit is connected to the receiving chamber, the second discharge conduit is connected to the receiving chamber, and wherein the coupling member and the receiving chamber cooperate in order to form a second flow conduit from the second supply bore to the second discharge conduit.

In an embodiment, a functionality is formed in the coupling body. Preferably, the functionality is a valve feature. In an embodiment, a part of the coupling body is a valve seat. The valve seat may preferably be a cast part of the coupling body. The functionality is thus (partly) incorporated into the coupling body, resulting in savings during production.

Further embodiments of the coupling body are described in the dependent claims. The measures of the further embodiments can, in particular, contribute to a further improvement of the coupling body, in particular for single-fuel and bi-fuel fuel systems.

According to a second aspect, a coupling housing is provided which coupling housing is provided with a first supply conduit for receiving a first fuel fluid and a first discharge conduit for discharging the first fuel fluid, which first supply conduit is connected to the first discharge conduit in the coupling body in order to form a fluid connection for the first fuel fluid from the first supply conduit to the first discharge conduit, in which the coupling housing is provided with a receiving chamber with an inner wall, wherein the first supply conduit extends up to the inner wall of the receiving chamber and the first discharge conduit extends from the inner wall of the receiving chamber, and wherein the receiving chamber is configured to accommodate a coupling member, wherein the coupling member and the receiving chamber cooperate in order to form a first fluid connection from the first supply bore to the first discharge conduit. In particular, it may be an advantage during installation and maintenance if the coupling housing and the coupling member can be installed and/or replaced individually.

According to a third aspect, a coupling member for a coupling body according to one of the abovementioned embodiments of the first aspect is provided, which coupling member is configured to form, together with the receiving chamber in the coupling body, a first fluid connection from the first supply bore in the coupling body to the first discharge conduit in the coupling body.

This coupling body may be cylindrical and is in particular bobbinet-shaped. In an embodiment, the coupling body comprises annular recesses.

According to a fourth aspect, a coupling body is provided wherein the coupling body is provided with a plurality of supply conduits for receiving a fuel fluid, a plurality of discharge conduits for discharging the fuel fluid, and a plurality of valve seats provided with valves, wherein

at least part of the supply conduits in the coupling body are connected to at least part of the discharge conduits in order to form fluid connections from respective supply conduits to discharge conduits,
the valve seats are provided in the coupling body, and the valves of the respective valve seats can be actuated in order to selectively open or close fluid connections between selected supply conduits and discharge conduits. Due to the fact that the supply and discharge conduits are provided in the coupling body and the valve seats are integrally formed with the coupling body, a strong and compact system is obtained, in which the flow path of fuel fluid can be controlled by selective opening and closing of the valves. In a first embodiment, one or more of the supply and discharge conduits in the coupling body may be connected to one another via a coupling member, as described above and/or, in another embodiment, be connected directly to one another.

According to the invention, the coupling body is furthermore provided with a first and a second fuel supply connection for respectively connecting fuel stores of a first and a second fuel fluid to a first and a second supply conduit in the coupling body, respectively, and is provided with a fuel discharge for connecting an internal combustion engine, and wherein the fluid connections from supply conduits to discharge conduits in the coupling body and the valve seats are configured to selectively supply the first fuel fluid, the second fuel fluid and/or a mixture of the first fuel fluid and the second fuel fluid to the fuel discharge to the internal combustion engine.

Moreover, the coupling body is combined with an expansion chamber situated between the discharges for the different fuels and the common connection to a fuel discharge line. Due to the presence of such a mixing chamber, the pressure of the fuel which is supplied at a higher pressure can be brought to the same pressure as the fuel which is supplied at a lower pressure in such a mixing chamber. In other words, it is for example possible to supply LPG supplied at a relatively high pressure and petrol supplied at a relatively low pressure to the coupling body wherein, by switching the respective valves, either petrol or LPG can be supplied to the common connection to a fuel discharge line. When switching from using LPG to petrol, the LPG which is at a higher pressure will be able to expand in the mixing space according to the present invention. An auxiliary pump may in addition be provided in this mixing chamber. By way of example, a value of a few tens of cubic centimetres to 100-200 cc is given for the volume of the mixing chamber. By using this mixing or expansion chamber, it is not necessary to take separate measures upstream from the coupling body in order to equalize the pressure of both fuels if there is a pressure difference between them. This means that it is not necessary to use auxiliary pumps upstream from the coupling body, as is the case in the prior art.

According to a fifth aspect, a fuel supply system is provided comprising a coupling body according to the first or the second aspect. Preferably, the fuel supply system is furthermore provided with a petrol supply, an LPG supply and a selection means, wherein the selection means is configured to selectively supply petrol or LPG to the coupling body. The selection means is for example a valve system by means of which the supply and/or the discharge of the fuel liquids can be controlled. In a further embodiment, the fuel supply system is furthermore provided with a mixing unit for mixing LPG and petrol in order to obtain an LPG/petrol mixture. By means thereof, in a bi-fuel system, the fuel supply system can advantageously switch between operating the internal combustion engine on petrol or LPG.

According to a sixth aspect, a vehicle is provided, for example a car, provided with a fuel supply system according to the fifth aspect. Such a vehicle can thus advantageously be provided with an LPG fuel supply system, in particular with a bi-fuel system.

According to another aspect, a coupling body is provided which provides a row of connection points for connecting to supply or discharge lines and/or a row of functionalities, such as a row of valve seats. In particular by providing a number of elements in a row, a device is obtained which can be readily fitted. In particular, the row of valve seats makes effective connection between the coupling body and control unit of the valve functionalities possible. Just like inventions according to the other aspects, the invention according to this seventh aspect can be combined with the measures indicated in the following description.

The invention will be described in more detail with reference to the attached drawings, in which:

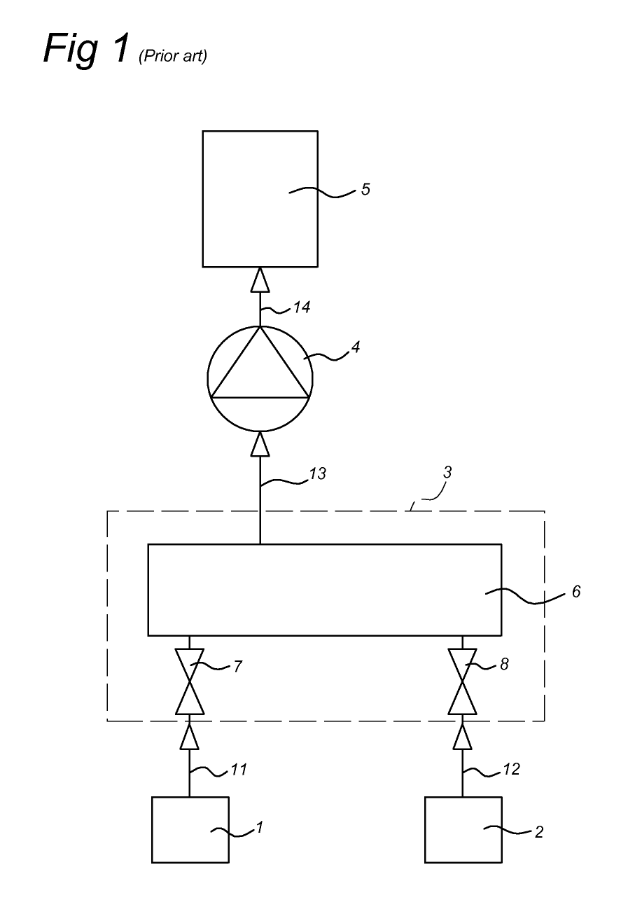

FIG. 1 shows a diagrammatic view of a known fuel supply system;

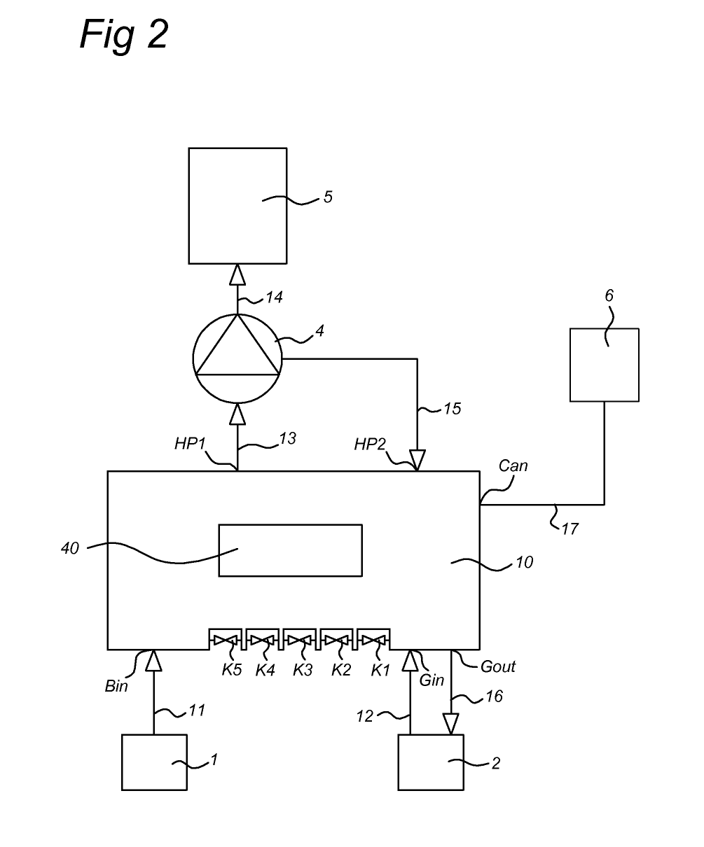

FIG. 2 shows a diagrammatic view of an embodiment of a fuel supply system according to the invention;

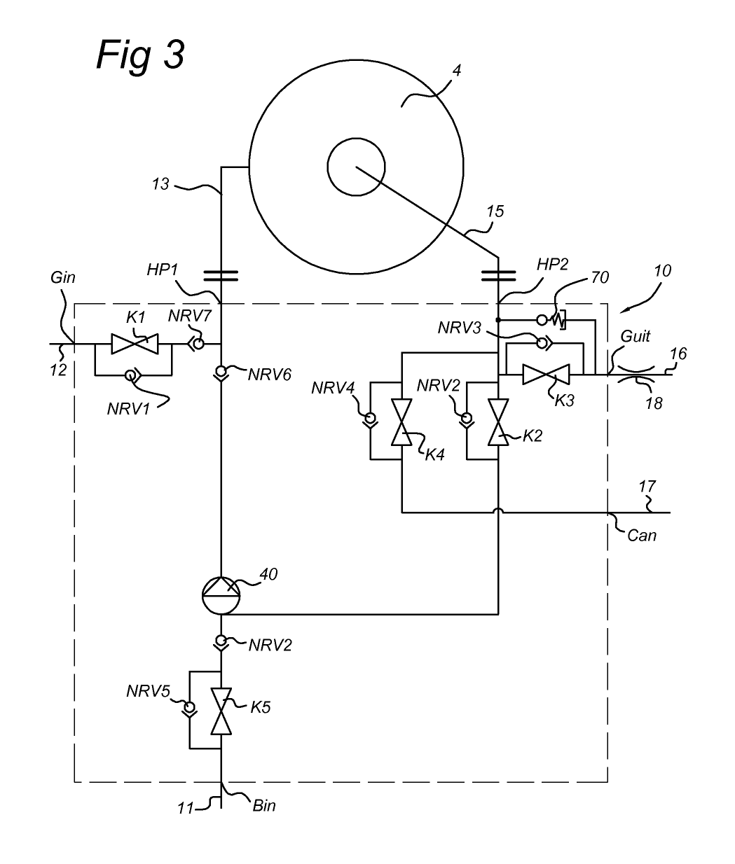

FIG. 3 shows a diagrammatic view of the operation of a fuel supply system according to the invention;

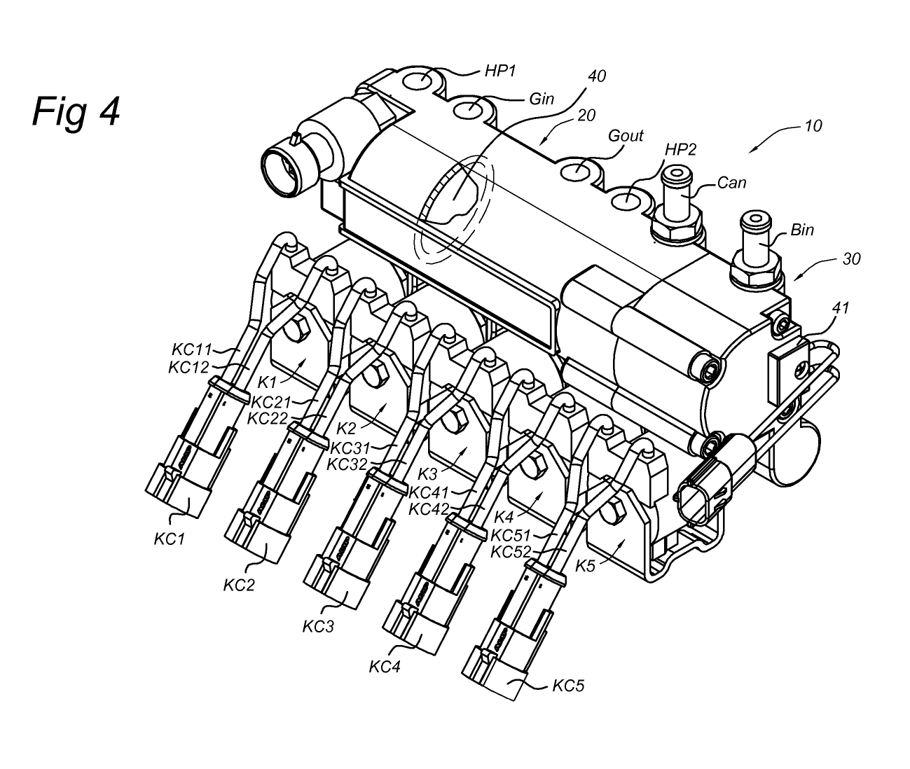

FIG. 4 shows a perspective partially cut-away view of an embodiment of a coupling body for a fuel supply system;

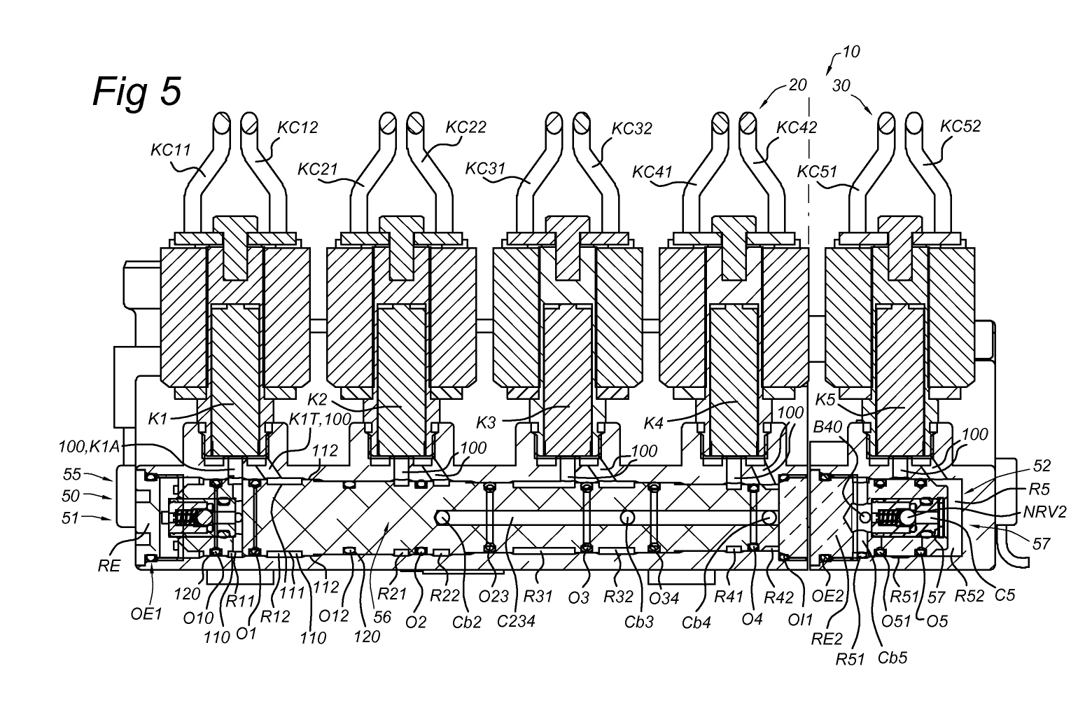

FIG. 5 shows a diagrammatic cross section of an embodiment of the coupling body from FIG. 4, in the presence of the coupling member;

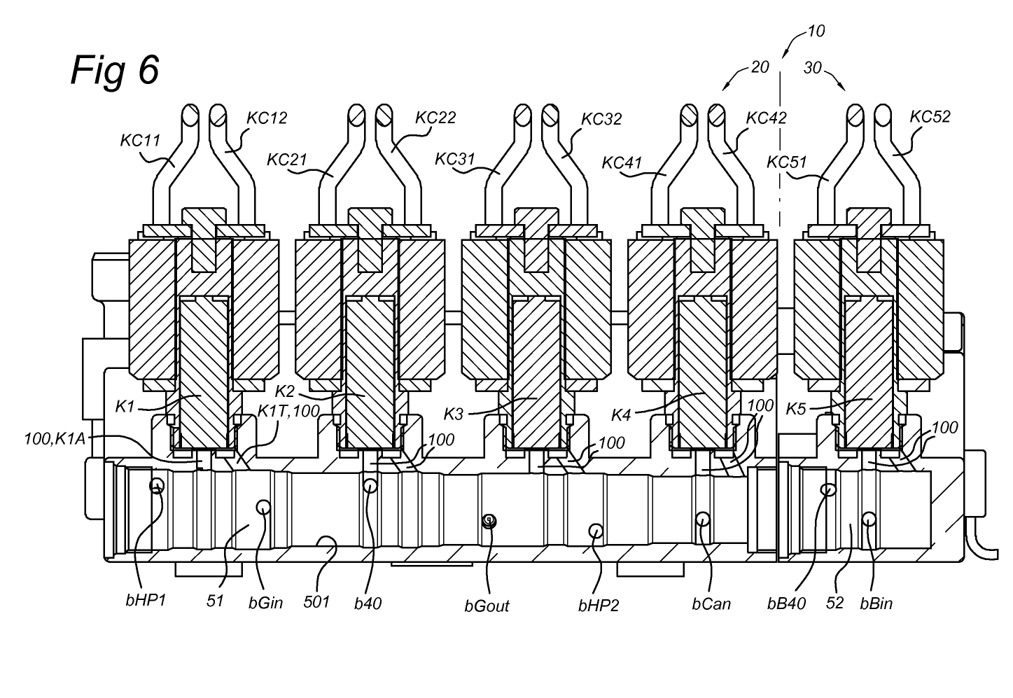

FIG. 6 shows a diagrammatic cross section in the absence of the coupling member;

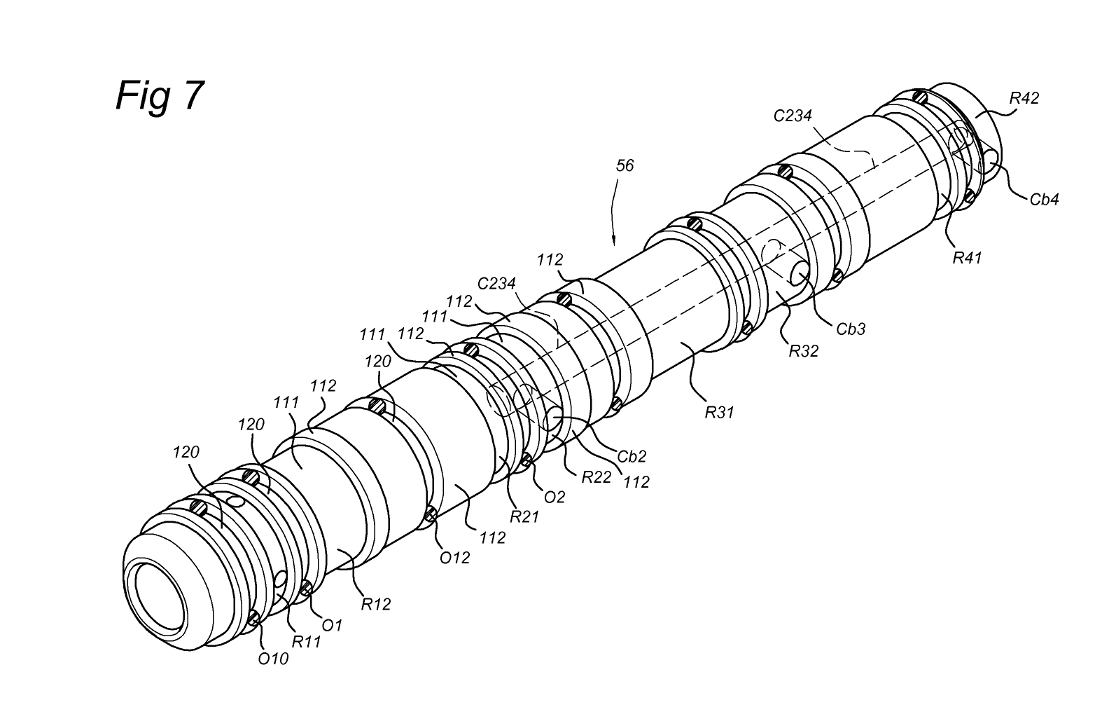

FIG. 7 shows a perspective view of an embodiment of a coupling member.

FIG. 1 diagrammatically shows a known bi-fuel fuel supply system. The known fuel supply system has a first fuel store 1 for petrol, a second fuel store 2 for LPG and an internal combustion engine 5. The internal combustion engine 5 can be operated both on petrol and LPG. Via a first fuel supply line 11 and a second fuel supply line 12, the first and second fuel stores 1, 2 can be connected to the internal combustion engine 5 by means of selection and coupling means 3 and a fuel discharge line 13, 14 which includes a high-pressure pump 4. The selection and coupling means comprise a first valve 7 in the first fuel supply line 11, a second valve 8 in the second fuel supply line 12, and a coupling body 6. The first valve 7 and the second valve 8 are fitted, for example, in the direct vicinity of the respective fuel store. When the first or second valve 7, 8 is opened, the first or the second fuel store 1, 2 is brought in fluid connection between the respective fuel store 7, 8 and the coupling body 6. FIG. 2 diagrammatically shows a bi-fuel fuel supply system according to the invention. Just like the known fuel supply system from FIG. 1, the fuel supply system comprises a first, low-pressure fuel store 1 for petrol, a second, high-pressure fuel store 2 for LPG and an internal combustion engine 5. The internal combustion engine 5 can be operated on both petrol and LPG, as well as on a suitable mixture thereof. Via a first fuel supply line 11 and a second fuel supply line 12, the first and second fuel store 1, 2 can be connected to the internal combustion engine 5 by means of a coupling body 10 and a fuel discharge line 13, 14, which preferably includes a high-pressure pump 4, as is shown.

In the embodiment shown in FIGS. 2 and 3, the high-pressure pump 4 is also coupled to the coupling body 10 by means of a return line 15, and from there to the second fuel store 2 via a further return line 16. A throttle valve 18 is incorporated in the return line 16. Furthermore, a canister 6 is connected to the coupling body 10 via a canister line 17. The connections between the various lines and the coupling body 10 will be denoted below using the following indications:
connection Bin is the connection between the first fuel supply line 11 and the coupling body 10;
connection Gin is the connection between the second fuel supply line 12 and the coupling body 10;
connection HP1 is the connection between the coupling body 10 and the fuel discharge line 13 (to the high-pressure pump 4);
connection HP2 is the connection between the return line 15 (from the high-pressure pump 4) and the coupling body 10;
connection Gout is the connection between the coupling body 10 and the further return line 16 to the second fuel store 2;
connection Can is the connection between the canister line 17 and the coupling body 10.

The coupling body 10 is furthermore provided with a row of valve seats K1-K5 (see FIG. 5) in which valves are fitted. Due to the fact that a row of valve seats is used, the connections to a control unit for the valves can be short and may be bundled.

In the following, the references K1-K5 may be used both for the valve seats and the respective valves. The connections Bin, Gin, HP1, HP2, Gout and Can are connected to respective conduits (see FIG. 6) in the coupling body 10. These conduits are formed by bores in the coupling body 10, and are connected to one another via the coupling body 10 and thus form fluid connections between, for example, different connections. The valves K1-K5 are incorporated in a number of these connections. The expression “closed valve” refers to the position of the valve in which the fluid connection is interrupted; the expression “open valve” refers to a position of the valve in which there is a fluid connection. These internal connections may be effected in different ways, as will be discussed in more detail below.

FIG. 3 diagrammatically shows the operation of a fuel supply system according to the invention and in particular the operation on petrol, LPG or the switch between these. By means of switching the various valves K1-K5 on the coupling body 10 on and off, it is possible to connect the first fuel supply line 11 or the second fuel supply line 12 to the inlet of the high-pressure pump 4 via the fuel discharge line 13. Valve K1 is provided in the connection between LPG connection Gin and connection HP1 to the fuel discharge line 13 to the high-pressure pump 4. Valve K3 is provided between connection HP2 and connection Gout. Also, a pressure-relief feature 70 is provided between connection HP2 and connection Gout. Valve K2 is provided in a connection between HP2 and a pump/mixing chamber 40. The pump/mixing chamber 40 is connected to connection HP1 to the high-pressure pump. When the pump is provided in the mixing chamber, the free volume thereof is 20-200 cc and more particularly approximately 80 cc. Valve K4 is provided in the connection between connection Can and the connection between connection HP2 and the valves K2 and K3, so that connection HP2 can be connected to connection Can by opening valve K4 and, by also opening valve K3, connection Gout can also be connected to connection Can. Valve K5 is provided in the connection between petrol connection Bin and the pump/mixing chamber 40. In addition, non-return valves NRV1-NRV5 are provided in various connections and/or parallel to the valves K1-K5 in order to prevent LPG from being able to flow to the first fuel store containing petrol. It will be clear that the non-return valves are not always required.

Non-return valves NRV6 and NRV7 prevent the fuels in the supply lines from becoming mixed and are situated just upstream from the node where the fuel supply lines meet. When the selected fuel is petrol, the valve K5 is open and the other valves K1-K4 are closed.

When the selected fuel is LPG, the valves K1 and K3 are open and the other valves K2, K4 and K5 are closed. In addition, the return line 15 of the high-pressure pump 4 will also be connected to the further return line 16 of the LPG tank.

When switching from petrol to LPG, first valve K5 is closed and then valves K1 and K3 are opened. The non-return valves prevent fuel from flowing into the wrong lines.

When switching from LPG to petrol, first valves K1 and K3 are closed. There still remains a small amount of LPG in the low-pressure part of the high-pressure pump 4. Then, valve K5 is opened. During the switching phase, the LPG which is still present in the low-pressure part of the high-pressure pump 4 is pumped to the pump/mixing chamber 40 via open valve K2 by a circulation pump, provided in the pump/mixing chamber 40, and is so mixed with the petrol which has been freshly supplied via open valve K5 and is already present in the pump/mixing chamber 40 in the coupling body 10. Upon entering the mixing chamber, the LPG, which is at a relatively high pressure, expands in the mixing chamber. This temporary mixture is processed in the usual way by the high-pressure pump and therefore combusts in the internal combustion engine. Typically, the amount of LPG which remains behind in the high-pressure pump is so small (for example 15 cc) that mixing it with a relatively small amount (for example 50 cc) of petrol already results in a vapour pressure which is lower than the normal supply pressure of the petrol pump, thus making a smooth and imperceptible switching strategy possible.

FIG. 4 is a perspective view of an embodiment of a coupling body 10 for a fuel supply system. FIG. 4 shows a coupling body 10 with a coupling housing composed of a first coupling housing 20 and a second coupling housing 30. In an alternative embodiment, the coupling housing 10 is formed by a single coupling housing. The first coupling housing 20 is provided with a row of connections UPI, Gin, Gout, HP2 and Can. The second coupling housing 30 is provided with the connection Bin. The first coupling housing 20 comprises a first space (not shown) which is connected to a second space (not shown) in the second coupling housing and together with the latter forms the pump/mixing chamber 40. FIG. 4 also shows a row of five valve seats with valves K1-K5, respectively provided with valve actuators KC1-KC5. The valve actuators KCn are each connected to hydraulic valve actuating lines KCn1, KCn2 connected to respective valves Kn, for each of the valves Kn, n=1, . . . , 5. The coupling body 10 is furthermore provided with a pump actuator 41.

FIG. 5 shows a diagrammatic cross section of an embodiment of the coupling body 10 from FIG. 4. The diagrammatic cross section shows the five valves K1-K5, with the respective hydraulic valve-actuating lines KCn1, KCn2 (n=1, . . . , 5). The diagrammatic cross section furthermore shows that the coupling body 10 is provided with a receiving chamber 50. In the illustrated embodiment, in which the coupling body 10 has a first coupling housing 20 and a second coupling housing 30, the receiving chamber 50 is formed by a first receiving chamber 51 in the first coupling housing 20 and a second receiving chamber in the second coupling housing 30. Each of the valves K1-K5 forms a controllable shut-off valve between a supply conduit and a discharge conduit 100 to the receiving chamber. These supply and discharge conduits are denoted by the general reference numeral 100. For valve K1, the supply conduit and discharge conduit are denoted by K1A and K1T, respectively.

The receiving chamber 50 comprises a substantially cylindrical coupling member 55. In the illustrated embodiment, in which the receiving chamber 50 is formed by the first receiving chamber 51 in the first coupling housing 20 and the second receiving chamber in the second coupling housing 30, the coupling member is formed by a first coupling member 56 in the first receiving chamber 51 and a second coupling member 57 in the second receiving chamber 52. The coupling member 55 is provided with local recesses 111 and has projections 112 which extend radially from the recesses and O rings 120 between the recesses 111, thus forming a plurality of annular flow conduits 110. The annular flow conduits 110 are denoted individually by R11, R12, . . . , R51, R52. Each annular flow conduit is connected to a supply or discharge conduit 100; for example annular flow conduit R11 is connected to supply conduit K1A and annular flow conduit R12 is connected to discharge conduit KIT. Each valve Kn is thus provided with two annular flow conduits, Rn1 and Rn2, and the valve Kn keeps the fluid connection between these two annular flow conduits Rn1 and Rn2 open or closed. The O rings are individually denoted by OE1, OE2, O1-O5, O10, O12, O23 and O34. O ring OE1 closes the first receiving chamber 51 off from ambient air. O ring OE2 closes the second receiving chamber 52 off from ambient air. O ring On separates the two annular conduits Rn1 and Rn2 which are connected to supply and discharge conduits, respectively, of valve Kn (n=1, . . . , 5); thus, for example, O ring O1 separates annular conduit R11 from annular conduit R12. O ring Onm separates, for example, annular conduits between adjacent valves: thus O ring O12 separates annular conduits R12 and R21.

The coupling member 50 may furthermore be provided with a conduit which is situated inside the coupling member. In the illustrated example, the first coupling member 51 is provided with a conduit C234 provided therein and the second coupling member 52 with a conduit C5 provided therein. Via conduits Cb2, Cb3 and Cb4 in the first coupling member 51, the internal conduit C234 is connected to the annular conduits R22, R32 and R42, respectively. Via a non-return valve NRV2 in the second coupling member 52, the internal conduit C5 connects the annular conduit R52 to a further annular conduit R50 which is connected to the pump/mixing chamber 40.

It is possible to configure an embodiment according to FIG. 5 of coupling body and coupling member in such a manner that operation in accordance with flow diagram 3 is possible.

FIG. 6 shows a diagrammatic cross section of the coupling body in the absence of the coupling member. In the wall of the first receiving chamber 51, the conduits are now visible which connect the first receiving chamber 51—and when the first coupling member 56 is provided therein the corresponding annular conduits—to the respective connections and the pump/mixing chamber 40. The figure shows conduit bHP1 to connection HP1, conduit bGin to connection Gin, conduit b40 to the pump/mixing chamber 40, conduit bHP2 to connection HP2 and conduit bCan to connection Can. In the wall of the second receiving chamber 52, the conduits bBin and bB40 are now visible which connect the receiving chamber 52—and when the second coupling member 57 is accommodated therein the corresponding annular conduits—to connection Bin and the pump/mixing chamber 40, respectively.

FIG. 6 also shows inner wall 501 of the receiving chamber 50. The inner wall is substantially cylindrical. The shut-off valves, such as O rings O1-O4, bear against the inner wall 501 and thus form barriers between the intermediary spaces which form the fluid connection conduits.

FIG. 5 shows conduit b40. Conduit b40 is a bore which is formed in coupling housing 30. The bore ends in intermediary space r50, which is connected to the internal conduit C5 via bore cb5.

FIG. 7 shows a perspective view of an embodiment of a first coupling member 51. For the description of FIG. 7, reference should be made to the above description of FIG. 5.

The following connections are thus obtained by means of the coupling body 10 illustrated in FIGS. 4-6 and the coupling member 51 illustrated in FIG. 6:
connection Gin is connected to annular conduit R12 by conduit bGin in the coupling body 10;
valve K1 is accommodated in the connection between annular conduit R12 and annular conduit R11;
annular conduit R11 is connected to connection HP1 via conduit bHP1 in the coupling body 10; in this connection a non-return valve is accommodated in order to prevent the fuel fluid from flowing back from HP1 to R11;
thus making it possible to obtain a fluid connection from connection Gin to connection HP1 by opening valve K1, as a result of which the high-pressure pump 4 is provided with LPG;
pump/mixing chamber 40 is connected to connection HP1 via conduit b40 in the coupling body 10; in this connection a non-return valve is accommodated in order to prevent the fuel fluid from flowing back from HP1 to the pump/mixing chamber 40 and to prevent a flow of the fuel fluid from Gin to the pump/mixing chamber 40;
annular connection R21 is connected to the pump/mixing chamber 40 via a conduit in the coupling body 10;
valve K2 is accommodated in the connection between annular conduit R21 and annular conduit R22;
annular conduit R22, annular conduit R32 and annular conduit R42 are connected to one another via conduit C234 provided in the first coupling member 51;
annular connection R31 is connected to connection Gout via conduit bGout in the coupling body 10; in this connection a non-return valve is accommodated in order to prevent the fuel fluid from flowing back from Gout to the coupling body;
valve K3 is accommodated in the connection between annular conduit R31 and annular conduit R32;
connection HP2 is connected to annular conduit R32 via conduit bHP2 in the coupling body 10;
thus making it possible to obtain a fluid connection from connection HP2 to the pump/mixing chamber 40 by opening valve K2, by means of which, when valve K3 is closed at the same time, LPG can flow back to the pump/mixing chamber 40 from the low-pressure side of the high-pressure pump 4 via the conduit C234. As the pump/mixing chamber 40 is connected to connection HP1, the high-pressure pump 4 can thus be provided with LPG or, when switching from LPG to petrol, with an LPG/petrol mixture;
by closing valve K2 and opening valve K3, a fluid connection from connection HP2 to connection Gout can be obtained, by means of which LPG can flow back from the low-pressure side of the high-pressure pump to the second fuel store 2 for LPG;
by means of the pressure-relief feature 70 between HP2 and Gout, a fluid connection between HP2 and Gout is obtained, independently of the position of the valves K1-K5, when the pressure on the low-pressure side of the high-pressure pump 4 is excessively high;
annular connection R41 is connected to connection Can via conduit bCan;
valve K4 is accommodated in the connection between annular conduit R41 and annular conduit R42;
thus, a fluid connection can be formed between connection Can and conduit C234 by opening valve K4 in order thus to relieve all volumes.
annular connection R51 is connected to connection Bin via conduit bBin in the second coupling body 30;
valve K5 is accommodated in the connection between annular conduit R51 and annular conduit R52;
by means of the second coupling member 52 accommodated in conduit C5, annular conduit R51 is connected to annular conduit R50; by means of conduit bB40 in the second coupling body 30 annular conduit R50 is connected to the pump/mixing chamber 40; in this connection a non-return valve is accommodated in order to prevent the fuel fluid from flowing back from the pump/mixing chamber 40 to Bin;
thus, a fluid connection can be formed between connection Bin and the pump/mixing chamber 40 by opening valve K5. As the pump/mixing chamber 40 is connected to connection HP1, the high-pressure pump 4 can thus be provided with petrol or, when switching from LPG to petrol, with an LPG/petrol mixture.

The valves K1-K5 may be pretensioned in different ways to a certain initial position. In this way, the valves are brought to a desired initial position when the device is without power supply. This may, in particular, be a position in which one of the fuels can readily be supplied to the combustion chamber.

Not all illustrated parts of the figures have been explained separately above. However, based on the above description, the operation will be clear to the person skilled in the art.

The coupling body 10 illustrated in FIGS. 4-6 has a coupling member 50 (as illustrated in FIG. 7) for connecting the various conduits in the coupling body to one another and/or to the valve seats with valves K1-K5. In an alternative embodiment, the conduits are connected directly to one another without the use of a coupling member, but valves K1-K5 are however incorporated in the respective connections, with the valve seats of the valves K1-K5 being accommodated in the coupling body, where it is necessary to be able to open and close the fluid connection in order to choose between petrol or LPG, and/or to switch from petrol to LPG and back.

Although the invention has been illustrated with reference to an embodiment, several embodiments are possible without departing from the scope of the invention. The person skilled in the art will understand that embodiments which have been described with reference to one or more specific types of fuel, for example petrol and LPG, can also be operated using other (combinations of) types of fuel.

1-27. (canceled)

28. A coupling body provided with a first supply conduit for receiving a first fuel fluid and a first discharge conduit for discharging the first fuel fluid, said first supply conduit in the coupling body being connected to the first discharge conduit in order to form a first fluid connection for the first fuel fluid from the first supply conduit to the first discharge conduit, wherein the coupling body is provided with a receiving chamber, wherein the first supply conduit is connected to the receiving chamber, the first discharge conduit is connected to the receiving chamber, and a coupling member is arranged in the receiving chamber, wherein the coupling member and the receiving chamber cooperate in order to form the first fluid connection, wherein the coupling body is provided with a second supply conduit for receiving the first or a second fuel fluid and with a second discharge conduit for discharging the first and/or the second fuel fluid, wherein the second supply conduit is connected to the receiving chamber, the second discharge conduit is connected to the receiving chamber, and wherein the coupling member and the receiving chamber cooperate in order to form a second fluid connection, wherein the second fluid connection connects the second supply conduit and the second discharge conduit to one another, wherein the first and second discharge conduit can be connected to a common connection with a fuel discharge line and wherein the coupling body is provided with a mixing chamber which is arranged directly upstream from said common connection.

29. A coupling body according to claim 28, wherein the receiving chamber comprises a substantially cylindrical bore with an inner wall, and the coupling member comprises a substantially cylindrical element which has a recess in order to form the first fluid connection at the location of the recess, between the inner wall of the substantially cylindrical bore and the substantially cylindrical coupling member.

30. A coupling body according to claim 29, wherein the coupling member comprises a first shut-off valve for shutting off the first fluid connection between the inner wall of the receiving chamber and the cylindrical coupling member in a longitudinal direction.

31. A coupling body according to claim 30, wherein the first shut-off valve comprises a plastic ring in order to radially define the position of the coupling member in the receiving chamber and to provide a closure for the first fuel fluid.

32. A coupling body according to claim 31, wherein the first fluid connection: (a) is substantially formed by a first annular flow conduit into which the first supply conduit extends and from which the first discharge conduit extends; or (b) comprises a conduit which is provided inside the coupling member.

33. A coupling body according to claim 28, further comprising a first discharge conduit for discharging the first fuel fluid, wherein the first further discharge conduit is connected to the receiving chamber, and wherein the first fluid connection is connected to the first further discharge conduit.

34. A coupling body according to claim 33, wherein the first discharge conduit and the second supply conduit are connected via a valve seat, wherein the valve seat is arranged in the coupling body, and the valve seat comprises a valve for opening and/or closing the connection between the first discharge conduit and the second supply conduit.

35. A coupling body according to claim 28, wherein the receiving chamber extends from an open end in the outer side of the coupling body up to a closed end inside the coupling body, and wherein the open end of the receiving chamber is preferably closed off with a removable closure.

36. A coupling body according to claim 28, further comprising a pressure-relief feature.

37. A coupling body according to claim 28, further comprising a pump chamber provided with a pump, wherein the pump is configured to pump at least the first fuel fluid through the coupling body.

38. A coupling housing for a coupling body according to claim 28, wherein the coupling housing comprises a first supply conduit for receiving a first fuel fluid and a first discharge conduit for discharging the first fuel fluid, which first supply conduit in the coupling housing can be connected to the first discharge conduit in order to form a first fluid connection for the first fuel fluid from the first supply conduit to the first discharge conduit, wherein the coupling housing comprises a receiving chamber, wherein the first supply conduit is connected to the receiving chamber and the first discharge conduit is connected to the receiving chamber, and wherein the receiving chamber is configured to accommodate a coupling member, wherein the coupling member and the receiving chamber cooperate in order to form the first fluid connection.

39. A coupling member for a coupling body according to claim 28, which coupling member is configured to form, together with a receiving chamber in the coupling body, the first fluid connection from the first supply conduit in the coupling body to the first discharge conduit in the coupling body.

40. A coupling member according to claim 39, wherein the coupling member comprises a substantially cylindrical coupling member which has a peripheral recess in order to form an annular flow conduit at the location of the recess.

41. A coupling member according to claim 40, wherein the coupling member comprises a conduit provided inside the coupling member, wherein the conduit provided inside the coupling member is preferably substantially formed by an axial internal conduit.

42. A coupling body comprising a plurality of supply conduits for receiving a fuel fluid, a plurality of discharge conduits for discharging the fuel fluid, and a plurality of valve seats provided with valves, wherein at least part of the supply conduits in the coupling body are connected to at least part of the discharge conduits in order to form fluid connections from respective supply conduits to discharge conduits, wherein the valve seats are provided in the coupling body, and the valves of the respective valve seats can be actuated in order to selectively open or close fluid connections between selected supply conduits and discharge conduits.

43. A coupling body according to claim 42, wherein the coupling body further comprises a first and a second fuel supply connection for respectively connecting fuel stores of a first and a second fuel fluid to a first and a second supply conduit in the coupling body, respectively, and is provided with a fuel discharge for connecting an internal combustion engine, and wherein the fluid connections from supply conduits to discharge conduits in the coupling body and the valve seats are configured to selectively supply the first fuel fluid, the second fuel fluid and/or a mixture of the first fuel fluid and the second fuel fluid to the fuel discharge (HP1) to the internal combustion engine.

44. A coupling body according to claim 28, wherein the coupling body is part of a fuel supply system that comprises the coupling body and at least one first fuel store, which first fuel store is connected via a first fuel supply to the first supply conduit of the coupling body.

45. The coupling body according to claim 44, wherein the fuel supply system comprises a petrol supply connected to a petrol store, an LPG supply connected to an LPG store and a selection means, wherein the selection means preferably comprises a plurality of valves in respective valve seats in the coupling body, and wherein the selection means is configured to selectively supply petrol or LPG.

46. The coupling body according to claim 45, wherein the fuel supply system further comprises a mixing unit for mixing LPG and petrol in order to obtain an LPG/petrol mixture.

47. A coupling body according to claim 44, wherein the coupling body is part of a vehicle that comprises the fuel supply system, at least one first and one second fuel store, and an internal combustion engine, wherein the fuel supply system is configured to supply the internal combustion engine with fuel from the first and/or the second fuel store during operation.
